(19) United States
(12) Patent Application Publication
(10) Pub. No.: US 2012/0081684 A1
(43) Pub. Date: Apr. 5, 2012

(54) Object Inspection Systems and Methods

(75) Inventors: Arie Jeffrey Den Oef, Waalre (NL); Yuli Vladimirsky, Weston, CT (US); Yevgeniy Konstantinovich Shmarev, Lagrangeille, NY (US); Luigi Scaccabarozzi, Warkenswaard (NL); Robert Albert, Sherman, CT (US); Richard David Jacobs, Brookfield, CT (US)

(73) Assignees: ASML Netherlands B.V., Veldhoven (NL); ASML Holding N.V., Veldhoven (NL)

(21) Appl. No.: 13/321,703

(22) PCT Filed: Apr. 13, 2010
(86) PCT No.: PCT/EP2010/054785

§ 371 Date: Nov. 21, 2011

Related U.S. Application Data
(60) Provisional application No. 61/219,158, filed on Jun. 22, 2009.

(51) Int. Cl. G03B 27/54; G01B 9/021; G01B 9/02

(52) U.S. Cl. 355/67; 356/489; 356/457

(57) ABSTRACT

Disclosed are systems and methods for object inspection, in particular for inspection of reticles used in a lithography process. The method includes interferometrically combining a reference radiation beam with a probe radiation beam, and storing their complex field images. The complex field image of one object is then compared with that of a reference object to determine the differences. The systems and methods have particular utility in the inspection of a reticle for defects.

### CROSS-REFERENCE TO RELATED APPLICATIONS

This application claims the benefit of U.S. provisional application 61/219,158 which was filed on 22 Jun. 2009, and which is incorporated herein in its entirety by reference.

### FIELD

Embodiments of the present invention generally relate to object inspection systems and methods, and in particular to object inspection systems and methods in the field of lithography, in which case the object to be inspected can for example be a reticle or other patterning device.

### BACKGROUND

Lithography is widely recognized as one of the key steps in the manufacture of integrated circuits (ICs) and other devices and/or structures. However, as the dimensions of features made using lithography become smaller, lithography is becoming a more critical factor for enabling miniature IC or other devices and/or structures to be manufactured.

A lithographic apparatus is a machine that applies a desired pattern onto a substrate, usually onto a target portion of the substrate. A lithographic apparatus can be used, for example, in the manufacture of ICs. In that instance, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned.

Current lithography systems project mask pattern features that are extremely small. Dust or extraneous particulate matter appearing on the surface of the reticle can adversely affect the resulting product. Any particulate matter that deposits on the reticle before or during a lithographic process is likely to distort features in the pattern being projected onto a substrate. Therefore, the smaller the feature size, the smaller the size of particles critical to eliminate from the reticle.

A pellicle is often used with a reticle. A pellicle is a thin transparent layer that may be stretched over a frame above the surface of a reticle. Pellicles are used to block particles from reaching the patterned side of a reticle surface. Although particles on the pellicle surface are out of the focal plane and should not form an image on the wafer being exposed, it is still preferable to keep the pellicle surfaces as particle-free as possible. For certain types of lithography (e.g., most extreme ultraviolet (EUV) lithography processes), however, pellicles are not used. When reticles are not covered, they are prone to particle contamination, which may cause defects in a lithographic process. Particles on EUV reticles are one of the main sources of imaging defects.

As well as particles, other anomalies in the mask patterns (such as misaligned, missing or deformed parts), are becoming smaller and therefore harder to detect with accuracy as the feature size decreases.

In the present disclosure (for all embodiments and variations), the inspection of an object is understood to be the examination of an object to assess whether it is free from defects. A “defect” is understood to be any anomaly from a desired characteristic, and in particular from a desired shape, pattern, surface profile or freedom from contamination that the object is meant to possess. A defect can for example be a particle (that either rests upon the object or is formed on the object), or a deformity such as an unwanted pit in the surface of the object, or a misaligned, missing or deformed part of the object.

Inspection and cleaning of an EUV reticle before moving the reticle to an exposure position can be an important aspect of a reticle handling process. Reticles are typically cleaned when contamination is suspected, as a result of inspection, or on the basis of historical statistics.

Reticles are typically inspected for defects using either scattered light techniques or scanning imaging systems.

Scanning imaging systems include for example confocal, EUV or electron beam microscope systems. An example of a confocal microscope system is disclosed in U.S. Pat. Application Publication No. 2006/0091334 to Urbach et al., published on May 4, 2006, and entitled, “Con-focal Imaging System and Method Using Destructive Interference to Enhance Image Contrast of Light Scattering Objects on a Sample Surface”. The system disclosed in this document employs destructive interference between a reference light beam and a probe light beam to enhance sensitivity of detection of defects on an otherwise flat surface. The system is tuned to maximize the destructive interference by adjusting the position of a set of mirrors to change the optical path length of the reference light beam to adjust its phase, and by rotating a set of polarizers to adjust the amplitude of the reference light beam. The tuning is carried out once for each object that is to be inspected, as a preparatory step before scanning and detecting the defects. Furthermore, because an optical subtraction technique is used, the beams need to be properly aligned to realize a proper subtraction.

With a scattered light technique, a laser beam is focused on a reticle and a radiation beam that is scattered away from a specular reflection direction is detected. Defects on an object surface will randomly scatter the light. By observing the illuminated surface with a microscope, the defects will light up as bright spots. The intensity of the spots is a measure of the size of the defect.

A scatterometer operating with visible or ultraviolet (UV) light allows significantly faster reticle inspection than scanning imaging systems (e.g., confocal, EUV or electron beam microscope systems). There are known scatterometers that use a laser radiation beam and a coherent optical system with a Fourier filter in the pupil plane that blocks light diffracted from a pattern on the reticle. This type of scatterometer detects light scattered by defects over the level of background coming from a periodic pattern on the reticle.

One example of such a system is described in U.S. Pat. Application Publication No. 2007/0258086 A1 to Bleeker et al., published on Nov. 8, 2007, and entitled, “Inspection Method and Apparatus Using Same.” As shown in FIG. 1, an exemplary inspection system 100 includes a channel 102 including a microscope objective 104, a pupil filter 106, a projection optical system 108, and detector 110. A radiation (e.g., laser) beam 112 illuminates an object (e.g., a reticle) 114. Pupil filter 106 is used to block optical scattering due to the pattern of object 114. A computer 116 can be used to control the filtering of pupil filter 106 based on the pattern of object 114. Accordingly, filter 106 is provided as a spatial filter in a pupil plane relative to object 114 and is associated with the patterned structure of object 114 so as to filter out radiation from the scattered radiation. Detector 110 detects a fraction of radiation that is transmitted by filter 106 for detection of contamination defects.

It is not feasible, however, to use an inspection system such as inspection system 100 on reticles having arbitrary (i.e., non-periodic) patterns. This limitation is a result of saturation of the detector by light diffracted by the pattern. The detector has limited dynamic range and cannot detect light from a defect in the presence of light scattered from the pattern. In other words, correspondent light can be efficiently filtered out by a spatial filter in a Fourier plane of a coherent optical system only for a periodic pattern. Even with a periodic pattern (e.g., for DRAM), there are significant issues when modifying a Fourier filter in a reticle scanning process. With an inspection system such as inspection system 100, there is also a limitation to use only a collimated radiation beam for its Fourier filtration. Therefore, it does not allow the illumination optimization necessary for suppression of scattering from reticle surface roughness.

Precision, quality, and certainty of defect detection is very often compromised when using known inspection systems. Scanning imaging systems such as critical dimension scanning electron microscopy (CDSEM) can be sensitive to small defects (for example, defects having a characteristic dimension of 100 nm or less, or preferably 20 nm or less), but is however a slow technique. However, faster optical techniques do not offer the very highest levels of detection sensitivity. With increasing demands for higher throughput and shrinking lithographic feature sizes, it is becoming increasingly important to enhance an inspection system's performance in terms of speed, smaller defect size detection, and immunity against unwanted effects.

### SUMMARY

An improved object inspection system is provided that can operate at a relatively high speed and is capable of inspecting small defects, as compared with existing techniques as exemplified above. In particular, the need to inspect defects of 100 nm or less, or even 20 nm or less is acutely felt in the field of extreme ultraviolet (EUV) lithography.

According to an embodiment, there is provided an object inspection system, including a radiation source arranged to emit a reference radiation beam; a radiation source arranged to emit a probe radiation beam to be incident on an object to be inspected; one or more optical elements arranged to interferometrically combine said reference radiation beam and said probe radiation beam; a storage medium arranged to store the complex field image of a reference object; and a comparator arranged to compare a complex field image of the object to be inspected with the stored complex field image of the reference object.

According to another embodiment, there is provided a method of inspecting an object including interferometrically combining a reference radiation beam with a probe radiation beam to obtain a complex field image of the object; storing the complex field image of the object; and comparing the complex field image of the object with a reference complex field image.

According to an embodiment, there is provided a lithography system having an object inspection system, the object inspection system including a radiation source arranged to emit a reference radiation beam; a radiation source arranged to emit a probe radiation beam to be incident on an object to be inspected; one or more optical elements arranged to interferometrically combine said reference radiation beam and said probe radiation beam; a storage medium arranged to store the complex field image of a reference object; and a comparator arranged to compare a complex field image of the object to be inspected with the stored complex field image of the reference object.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

Embodiments of different aspects of the present invention will now be described, by way of example only, with reference to the accompanying schematic drawings, in which corresponding reference symbols indicate corresponding parts, wherein:

FIG. 1 depicts an example of a known object inspection system using scatterometry;

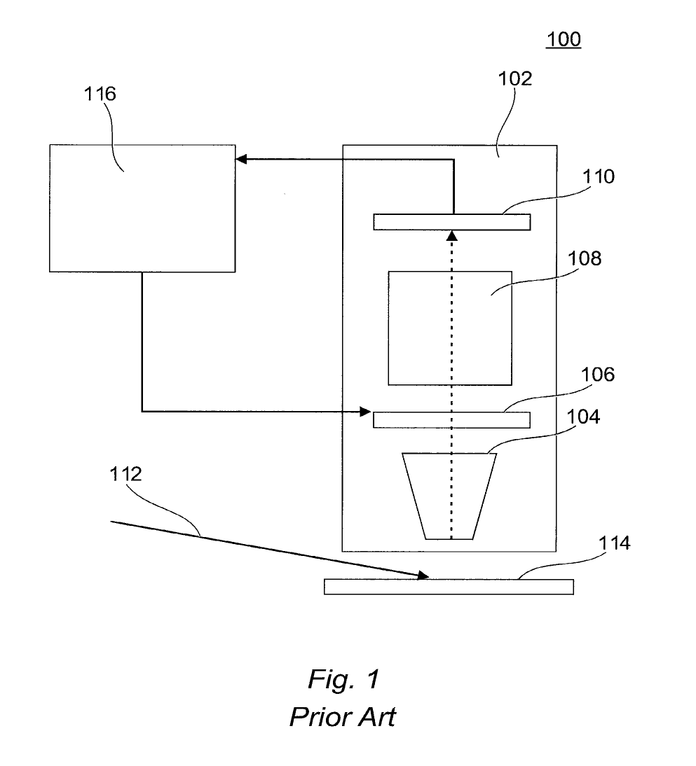

FIG. 2 depicts an embodiment of an object inspection system, employing a tilted reference beam that interacts with a probe beam;

FIG. 3 depicts an embodiment of an object inspection system in a recording mode, where a reference image is recorded on an optical storage device;

FIG. 4 depicts an embodiment of an object inspection system where a reference image is recorded on an optical storage device, this time in an inspection mode, where an object image is compared to a reference image recorded on an optical storage device;

FIG. 5 depicts an embodiment of an object inspection system, where a phase stepped reference beam is interfered with a probe beam;

FIG. 6 depicts an embodiment of an object inspection system including a vibration compensation device;

FIG. 7 depicts an embodiment of an object inspection system where a specular reflection is used as a phase-stepped reference beam;

FIG. 8 depicts a reflective lithographic apparatus;

FIG. 9 depicts a transmissive lithographic apparatus; and

FIG. 10 depicts an example EUV lithographic apparatus.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Embodiments of the present invention are directed to object inspection systems and methods. This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention or of various component parts of the invention may be implemented in hardware, firmware, software, or any combination thereof. Embodiments of various component parts of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines or instructions may be described herein as performing certain actions. However, it should be appreciated that such descriptions are merely for convenience and that such actions in fact result from computing devices, processors, controllers, or other devices executing the firmware, software, routines, instructions, etc.

The following description presents systems and methods of object inspection that allow particle and defect detection of an object.

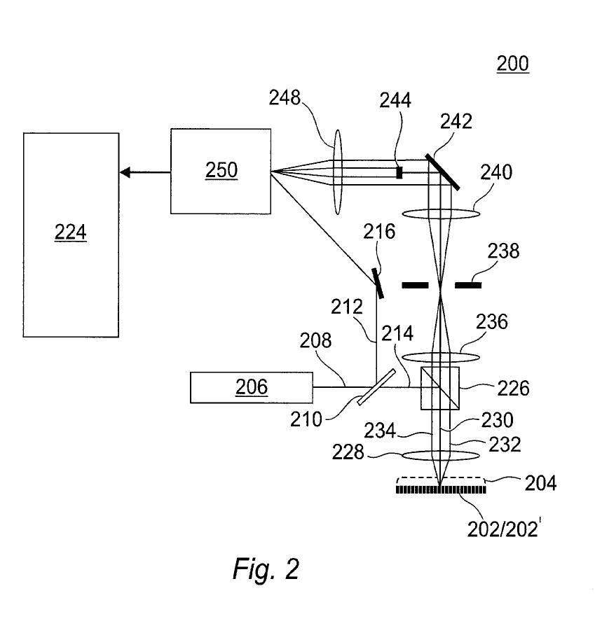

FIG. 2 schematically depicts object inspection system 200, according to an embodiment of the present invention. The object inspection system 200 is arranged to inspect an object 202, which can for example be a reticle. The reticle may also optionally include a pellicle 204 (or a glass window, for example), shown in phantom, for protection from contamination. The choice of whether to include a pellicle or not depends on the particular lithographic process and lithography apparatus configuration for which the reticle 202 is to be used.

Object inspection system 200 includes a radiation source 206. A radiation beam 208 from the radiation source 206 is split by a beam splitter 210 into a reference beam 212 and a probe beam 214. The reference beam 212 is reflected by a reflective element 216, which can be a mirror or a prism for example.

The probe beam 214 emitted from the beam splitter 210 is reflected by a second beam splitter 226 through an objective lens 228 which focuses the probe beam 214 on an object 202. When included, the pellicle 204 is out of the plane of focus of the objective lens 228.

The probe beam 214 is then reflected from the object 202. The specular reflection is represented by the 0^{th} order reflected light 230. Higher orders are also generated by the pattern of the surface of the object. For ease of illustration, only the positive first order 232 and negative first order 234 are shown, however it is to be appreciated that further orders may also be present. The number of further orders that are collected by the system depends upon the parameters of the system including the optical properties of the objective lens 228.

The reflected light passes back through the beam splitter 226. Lens 236 collects the reflected light and focuses it through a field stop 238, lens 240 and reflective element 242. A spatial filter 244 may be provided which blocks the 0^{th} order reflected light of the probe beam 214 (FIG. 2 also shows edge rays that are diffracted by the edge of the spatial filter 244). The remaining orders are focused by lens 248. The tilted reference beam 212 then interferes with the transmitted probe beam 214, so the light incident on the detector 250 includes the remaining orders of the probe beam 214 interfered with the tilted reference beam 212, forming an interference fringe pattern.

The interference fringe pattern then allows reconstruction of the complex wave front of the object, as known to a person skilled in the art. Because a tilted reference beam is used, destructive interference does not occur over the full image plane. Instead, phase modulated interference fringes are obtained. This is normally referred to as spatial heterodyning. The phase distribution of the object image is recovered via the positional variations of the dense fringe pattern. Computer 224 is provided to receive an output from the detector 250 and perform the necessary computations. In this embodiment the detector can for example be a solid state image sensor, for example a CCD or CMOS image sensor.

The optical path that runs from radiation source 206 to reflective element 216 to detector 250 represents a reference path or branch, and the optical path that runs from radiation source 206 to object 202 to detector 250 represents a probe path or branch. It is to be appreciated that the optical path length difference between the reference branch and the probe branch should be less than a coherence length of the illumination source 206. The various components that are provided in each of the branches (both in FIG. 2 and in other embodiments) that perform optical functions are referred to as “optical components”. The optical components may for example include reflective elements, interferometer elements, beam splitters, lenses, field stops and any other components that perform an optical function.

Once the system 200 has been used to image an object 202 in the manner described above, it can then be used to image a second object 202′ in the same way. This can be achieved either by moving the system (at least in part), or by removing the object 202′ and replacing it by the new object 202′.

The computer 224 then compares the complex object field of the first object 202 and the new object 202′, for example by performing a subtraction of one from the other. In this way, differences between the two objects can be easily observed. This means that, when the object 202 is a reference reticle and the new object 202′ is a test reticle that is meant to have the same pattern as the reference reticle 202, the similarity can be verified and the new object 202′ can be tested for the presence of defects.

The radiation source 206 may in some embodiments be a monochrome laser.

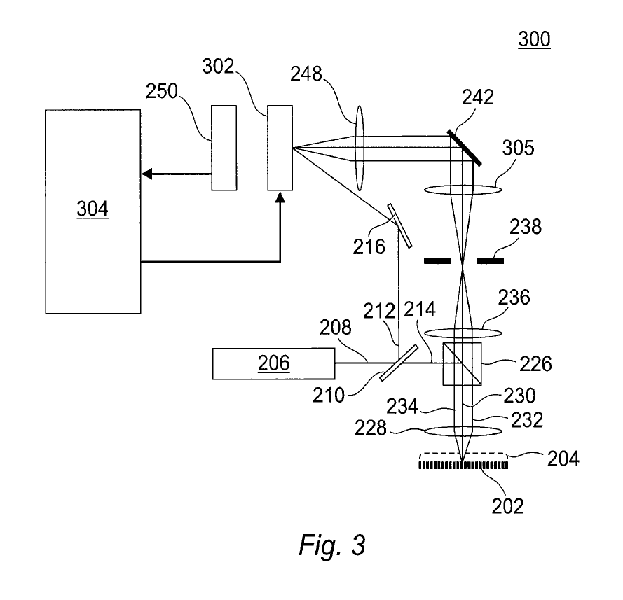

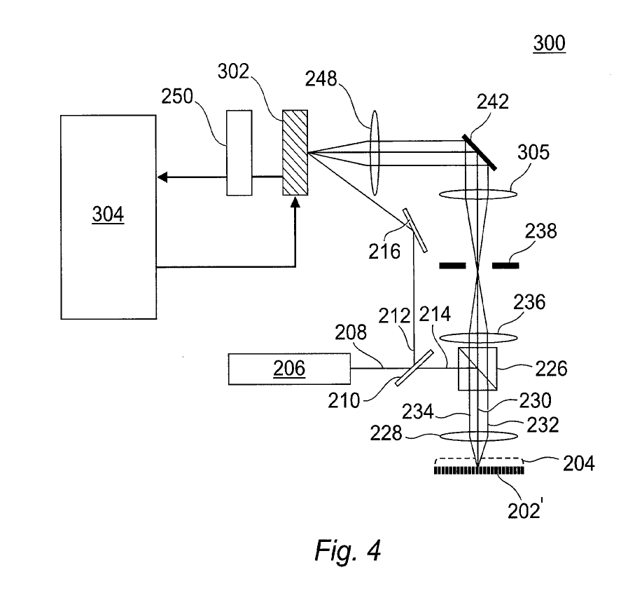

The use of a tilted reference wave as shown in FIG. 2 requires that the detector has a relatively high resolution in order to resolve the fringe pattern that is obtained as a result of the interference between the tilted reference beam 212 and the probe beam 214. FIGS. 3 and 4 schematically depict object inspection system 300 according to an embodiment of the present invention, in which the complex field images (or “phase images”) are stored optically rather than digitally.

Firstly, a recording mode is depicted in FIG. 3. Several components of an object inspection system 300 are similar to those shown in FIG. 2, and are illustrated with the same reference numerals as used in FIG. 2. Spatial filter 244 may be included, but has been omitted from the diagram for ease of illustration.

An optical storage device 302 can be provided in front of the detector 250. The optical storage device 302 can be a 3D optical storage device such as a holographic plate or crystal. Lens 305 operates as a magnification system.

As seen for FIG. 2 above, the tilted reference beam 212 interferes with the transmitted probe beam 214, so the light incident on the optical storage device 302 includes the probe beam 214 (preferably missing the 0^{th} order, which can be blocked by the spatial filter) interfered with the tilted reference beam 212, forming an interference fringe pattern. This interference fringe pattern is stored on the optical storage device 302. A computer 304 can be provided to control the location of recording on the optical storage device 302. In this way, the complex field image of an object 202 is stored on the optical storage device 302.

In an embodiment, the recording on the optical storage device 302 is performed only once, just after fabrication of the object 202. The storage device 302 will then always stay with the object 202. In this way the storage device 302 can be used as reference in a different system 300, so that object 202 can be inspected at, e.g., a different location, in a different system.

During recording, the detector 250 is usually inactive, however in alternative embodiments it may be used for monitoring purposes, for example, for monitoring light intensity noise data.

An inspection mode of the same system 300 is then depicted in FIG. 4, in which a test object 202′ is tested for similarity with the stored object 202. The optical storage device 302, on which the image of the object 202 has been recorded, is placed within a reference branch and the reconstructed reference image is combined in opposition of phase with the image of the test object 202′.

If the image of test object 202′ is the same as the image of the reference object 202, there will be no signal incident on the detector 250. If there is a defect, it will appear as a bright spot on the detector 250.

Because the image is stored optically (in a holographic plate or a crystal), no fast electronics or complex, large solid state image sensors are required. The high resolution, data storage capacity and recording speed of holographic optical storage are also advantageous. Because data processing is done in the optical domain, it can be performed extremely quickly (real time). Furthermore, the inspection time can be very short. Ideally the entire object (or reticle) can be inspected at once (given sufficiently homogenous and large illumination and detection systems).

The holographic plate does not need to have the same resolution as the mask. Suitable magnification optics can be employed such that the features on the plates may be (much) larger than the features on the mask, limited by the largest size of the plate available. Because of this, alignment of the mask signal to the plate signal is also much less challenging. Increasing the magnification may also mitigate any deformation of a holographic plate or crystal.

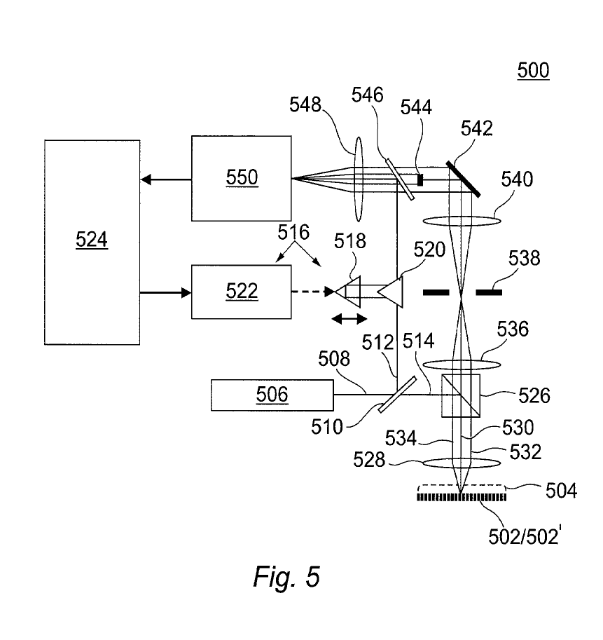

FIG. 5 schematically depicts object inspection system 500 according to an embodiment of the present invention, and which can function with lesser resolution detectors than the embodiment shown in FIG. 2, if desired. The object inspection system 500 is arranged to inspect an object 502, which can for example be a reticle. The reticle may also optionally include a pellicle 504 (or a glass window, for example), shown in phantom, for protection from contamination. The choice of whether to include a pellicle or not depends on the particular lithographic process and lithography apparatus set up for which the reticle 502 is to be used.

Object inspection system 500 includes a radiation source 506. A radiation beam 508 from the radiation source 506 is split by a beam splitter 510 into a reference beam 512 and a probe beam 514. The reference beam 512 passes through an interferometer element 516 that introduces a phase shift to the reference beam 512. The interferometer element 516 is adjustable to introduce a selectable phase shift. In the embodiment illustrated in FIG. 5, the interferometer element includes two reflective elements 518, 520 and a phase controller 522.

The reflective elements 518, 520 can be mirrors or prisms, for example. The phase controller 522 includes an actuator for adjusting the relative position of the reflective elements 518, 520. In the specific example of FIG. 5, reflective element 518 is movable, as represented by the arrowheads beneath the reflective element 518. It is to be appreciated that the relative position of the reflective elements 518, 520 may be adjusted by moving one or both of the reflective elements 518, 520. The phase controller 522 is operable according to instructions received from a computer 524.

The adjusted relative position between the reflective elements changes the optical path length of the reference beam 512, and thus the phase difference that is applied to the reference beam 512. The interferometer element 516 thus can be operated to apply a selected phase shift to the reference beam 512.

In an alternative embodiment, the interferometer element 516 can include an electro-optic modulator, for example of the type employing a crystal whose refractive index can be varied by the application or variation of an electric field across the crystal.

The probe beam 514 that is transmitted by the beam splitter 510 is reflected by a second beam splitter 526 through an objective lens 528 which focuses the probe beam 514 on an object 502. When included, the pellicle 504 is out of the plane of focus of the objective lens 528.

The probe beam 514 is then reflected from the object 502. The specular reflection is represented by the 0^{th} order reflected light 530. Higher orders are also generated by the pattern of the surface of the object. For ease of illustration, only the positive first order 532 and negative first order 534 are shown, however it is to be appreciated that further orders may also be present. The number of further orders that are collected by the system depends upon the parameters of the system including the optical properties of the objective lens 528.

The reflected light passes back through the beam splitter 526. Lens 536 collects the reflected light and produces a magnified image of the object 502 on a field stop 538, lens 540 and reflective element 542. A spatial filter 544 may be provided which blocks the 0^{th} order reflected light from the beam splitter 546 (FIG. 5 also shows edge rays that are diffracted by the edge of the spatial filter 544). Higher orders of the reflected light are passed through the beam splitter 546. The reference beam 512 is also incident on the beam splitter 546, so that the light transmitted by the beam splitter 546 towards an imaging lens 548 includes the non-zero orders of the reflected light, plus the phase shifted reference beam 512.

The phase shifted reference beam 512 interferes with the reflected light in the probe beam 514 exiting the beam splitter 546, creating an interference pattern on the detector 550. In this embodiment the detector can for example be a solid state image sensor, for example a CCD or CMOS image sensor. Images detected by the detector 550 are stored in a storage medium 524 which in this example is a computer.

The interferometer element 516 can then be operated to apply a succession of different phase shifts, and an interference pattern can be recorded for each phase shift. Each interference in the series of interference patterns is represented by the following equation:

Iₙ=|R_{ref}|²+|R_{obj}|²+2|R_{ref}∥R_{obj}|cos(ψ_{obj}+nΔφ)

In this equation, Iₙ is the intensity of the n^{th} interference pattern in the series; R_{ref} is the complex scattered field of the reference beam 512, R_{obj} is the complex scattered field of the probe beam 514, ψ_{obj} is the phase of the scattered probe beam 514 and φ represents the phase shift applied to the reference beam 512, which is multiplied by a factor of n representing the phase step that is applied for the n^{th} interference pattern.

In practice at least three phase steps are needed to reconstruct the complex object wavefront. However if a greater number of phase steps are performed, the Signal-to-Noise ratio can be improved and phase step errors can be reduced. Typically, several tens or hundreds of phase steps may be applied. Also, it should be noted that the phase steps do not necessarily have to be equal.

The interference patterns from the various phase steps are then used to reconstruct the complex field image of the object 502. The complex field image may also be referred to as a phase image, that is, image data that includes phase information.

Once the system 500 has been used to image an object 502 in the manner described above, it can then be used to image a second object in the same way. This can be achieved either by moving the system (at least in part), or by removing the object 502 and replacing it with the new object 502′.

The computer 524 then compares the complex object field of the first object 502 and the new object 502′, for example by performing a subtraction of one from the other. In this way, differences between the two objects can be easily observed. This means for example that, when the object 502 is a reference reticle and the new object 502′ is a test reticle that is meant to have the same pattern as the reference reticle, the similarity can be verified and the new object 502′ can be tested for the presence of defects.

The radiation source 506 may in some embodiments be a monochrome laser. However in alternative embodiments the radiation source 506 may be a source that emits radiation at a number of different wavelengths, and as a specific example might be a white light source.

The use of a radiation source 506 that emits radiation at a number of different wavelengths enables the gathering of spectroscopic information of the scattered field as well. For each phase step, the complex field of many different wavelengths can be measured and stored simultaneously. This allows wavelength-dependent scattering properties to be exploited as an extra discriminating factor, which can help improve the detectability of defects, as a defect may typically exhibit a different spectroscopic response than that of the surface of the object being imaged. To enable this spectroscopic distinguishability with the same image resolution as for a monochrome light source, typically a larger number of phase steps will be required as compared with the number that would be required for a monochrome source. A total movement range of at least λ²/Δλ is required, where λ is the center wavelength and Δλ is the required spectral resolution. As an example, for a resolution of 10 nm and a mean wavelength of 400 nm, a range of 16 μm or more would be needed, and the total number of phase steps would be somewhere in the range of 100-1000.

The optical path that runs from radiation source 506 to interferometer element 516 to detector 550 represents a reference path or branch, and the optical path that runs from radiation source 506 to object 502 to detector 550 represents a probe path or branch. It is to be appreciated that the optical path length difference between the reference branch and the probe branch should be less than a coherence length of the illumination source 506.

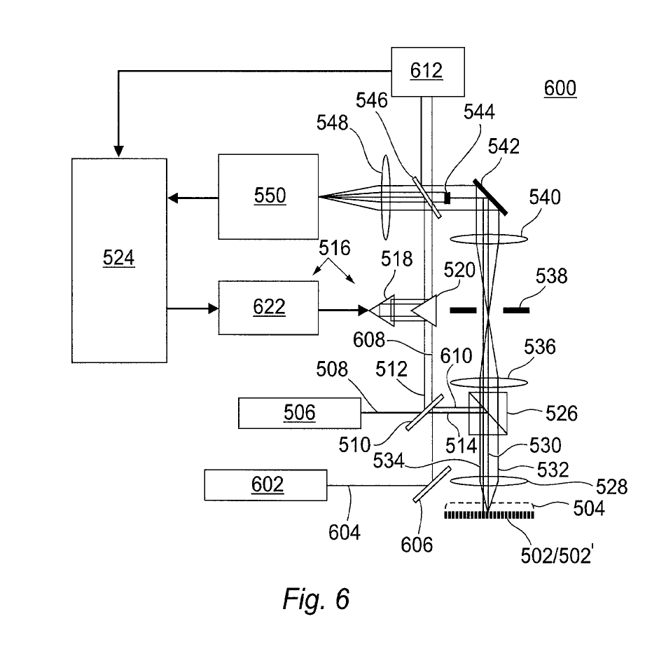

FIG. 6 schematically depicts an object inspection system 600 according to an embodiment of the present invention and which includes a device that can compensate for vibration of an object being inspected. This vibration compensation device can be used in any of the object inspection systems illustrated in FIGS. 2 to 5, although for ease of reference FIG. 6 illustrates the example of a vibration compensation device as would be incorporated with the object inspection system of FIG. 5. The basic principle of image processing and object inspection is similar to that discussed above with reference to FIG. 5 and elements of the object inspection system 600 are illustrated with the same reference numerals as used in FIG. 5 where appropriate.

The object inspection system 600 includes a monitor light source 602 which is used to measure variations in the optical path difference between the measurement branch and the reference branch. Radiation beam 604 emitted from the monitor light source 602 is passed through the beam splitter 510, optionally via reflective element 606. Beam splitter 510 splits the monitor radiation beam 604 into a monitor reference beam 608 and a monitor probe beam 610. The monitor reference beam 608 is processed in the same way as the reference beam 512 from the main light source 506 is processed, following the same branch. Similarly, the monitor probe beam 610 is also processed in the same way that the probe beam 514 from the main light source 506 is processed, following the same branch. In the example of FIG. 6 the monitor reference beam 608 has a phase change introduced by interferometer element 516. The monitor reference and probe beams 608, 610 are both received by monitor detector 612, after being reflected from/transmitted through beam splitter 546. Monitor detector 612 feeds the information it receives into the computer 524 for incorporation into the calculations it performs.

The monitor detector 612 receives the reference beam 608 and the probe beam 610 before they are combined to have their interfered combination detected at the detector 550. This therefore acts to measure the variations between the optical path lengths of the two branches. Any vibrations that occur between the object and the system either by movement of the object, movement of the system or movement of components within the system will result in a change in the optical path length difference between the two branches. These differences can be picked up by the monitor detector and fed to the computer 524 where they can be taken account of in the analysis of the images.

The difference in optical path length which is detected can be translated to an alignment error to be applied to shift the images in the processing of the computer to improve the accuracy of detection of defects.

The monitor light source can for example be a near infra-red laser diode, although any other suitable light source can be used.

The monitor light source 602 may illuminate an extended area over the object 502, 502′ under inspection.

The optical path that runs from radiation source 506 to interferometer element 516 to detector 550 represents a reference path or branch. The optical path that runs from radiation source 506 to object 502 to detector 550 represents a probe path or branch. The optical path that runs from monitor radiation source 602 to interferometer element 516 to detector 550 represents a monitor path or branch. It is to be appreciated that the optical path length difference between the reference branch and the probe branch should be less than a coherence length of the illumination source 602.

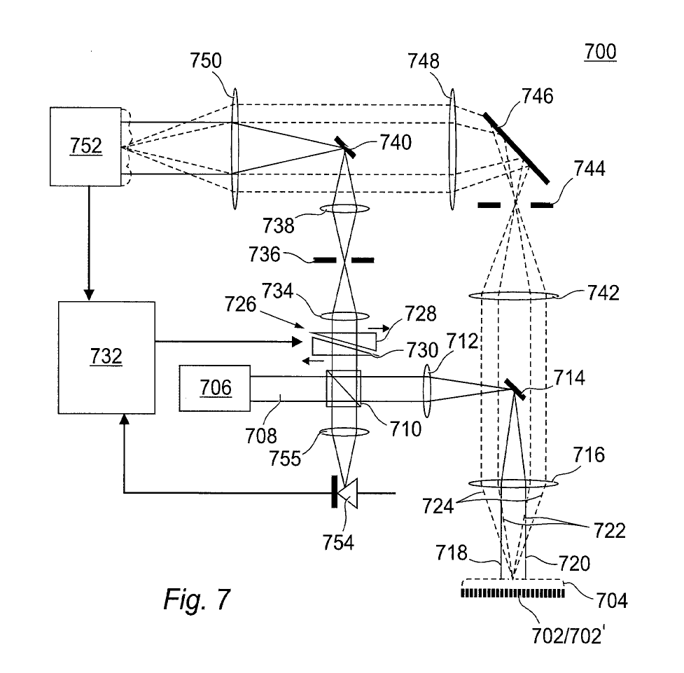

FIG. 7 shows an alternative embodiment of an object inspection system 700, in which an object 702 is perpendicularly illuminated and the 0^{th} order reflected light (i.e. the specular reflection) is used as a reference branch to interferometrically measure the complex amplitude of the dark field image that is projected on to the detector 752. This arrangement for dark field imaging can also be used with any of the methods corresponding to the apparatuses of FIGS. 3 to 6.

The object inspection system 700 is arranged to inspect an object 702, which can for example be a reticle. The reticle may also optionally include a pellicle 704 (or a glass window, for example), shown in phantom, for protection from contamination. The choice of whether to include a pellicle or not depends on the particular lithographic process and lithography apparatus set up for which the reticle 702 is to be used.

The optical path that runs from radiation source 706 to the object 702 and then to the interferometer element 726 and to the detector 752 represents a reference path or branch. The optical path that runs from radiation source 706 to object 702 to detector 752 without passing through the interferometer element 726 represents a probe path or branch. It is to be appreciated that the optical path length difference between the reference branch and the probe branch should be less than a coherence length of the illumination source 706.

Object inspection system 700 includes a radiation source 706. A radiation beam 708 from the radiation source 706 passes through beam splitter 710 and lens 712, and is then reflected by reflective element 714 towards an objective lens 716 which focuses the radiation on the object 702. The incident radiation is then reflected from the object 702. When included, the pellicle 704 is out of the plane of focus of the objective lens 716. The specular reflection (0^{th} order reflected light) is shown at 718, 720. Higher orders are also generated by the pattern of the surface of the object. For ease of illustration, only the positive and negative first orders 722 and positive and negative second orders 724 are shown, however it is to be appreciated that further orders may also be present. The number of further orders that are collected by the system depends upon the parameters of the system including the optical properties of the objective lens 716.

The specular reflection 718, 720 is intercepted by reflective element 714 and passed back through lens 712 and beam splitter 710. The reflective element 714 is sized so that the 0^{th} order reflected light is intercepted but the other orders are allowed to pass. The chosen dimensions of the reflective element 714 depend on the characteristics of the other component parts of the system 700, including for example the dimensions and optical properties of the lenses used.

After being reflected by the beam splitter 710, the specular reflection beam passes through interferometer element 726 which introduces a phase shift. The interferometer element 726 is adjustable to introduce a selectable phase shift. In the embodiment illustrated in FIG. 7, the interferometer element 726 includes two counter-propagating wedges 728, 730. This arrangement may be chosen as it allows a relatively large optical path difference to be implemented as compared with the capabilities of other available phase steppers. However it is to be appreciated that there are many other methods of introducing phase stepping, which may replace the wedges 728, 730 of FIG. 7 as desired, including for example a Pockel's cell, Kerr cell, LCD (Liquid Crystal) phase shifter, piezo-driven mirror/corner cube, Soleil Babine compensator and so on.

The interferometer element 726 is controlled by a phase controller, which is illustrated in FIG. 7 as part of a computer/controller module 732. As an alternative implementation, the phase controller and computer may be incorporated as separate devices, in which case the phase controller can be operated by the computer (this example implementation can be seen by the corresponding computer in FIGS. 5 and 6). When implemented as shown in FIG. 7, the computer/controller module 732 can take the form of a specialized machine including a mixture of hardware and software components, with one or more user interfaces.

In the specific example of FIG. 7, the wedges 728, 730 are movable in opposite directions, as represented by the arrowheads at each wedge.

The wedges 728, 730 change the optical path length of the incident beam, and thus a phase difference is introduced. The amount of phase difference that is applied can be varied by varying the amount by which the wedges 728, 730 are moved. The interferometer element 726 can thus be operated to apply a selected phase shift to the incident beam.

The phase shifted specular reflection beam is then focused and filtered by lens 734, field stop 736 and lens 738 before being incident on a reflective element 740, which acts to direct the specular reflection beam to join the optical path of the probe branch (which is discussed below).

The non-zero orders of radiation reflected from the object 702 are not intercepted by the reflective element 714, and form a probe branch. The non-zero order reflected radiation passes through lenses 716 and 742 and field stop 744 before being reflected by reflective element 746 and passed through lens 748. The radiation in the probe branch is not intercepted by the reflective element 740. The probe branch and the reference branch are then both incident on the lens 750. The interference between the probe beam and the reference beam then creates an interference pattern on the detector 752. In an embodiment the detector is a solid state image sensor, for example a CCD or CMOS image sensor. Images detected by the detector 752 are stored at the computer/controller module 732.

The interferometer element 726 can then be operated to apply a succession of different phase shifts, and an interference pattern can be recorded for each phase shift. Each interference in the series of interference patterns is represented by the following equation:

Iₙ=|R_{ref}|²+|R_{obj}|²+2|R_{ref}∥R_{obj}|cos(ψ_{obj}+nΔφ)

In this equation, Iₙ is the intensity of the n^{th} interference pattern in the series; R_{ref} is the complex scattered field of the reference beam, R_{obj} is the complex scattered field of the probe beam, ψ_{obj} is the phase of the scattered probe beam, and Δφ represents the phase shift applied to the reference beam, which is multiplied by a factor of n representing the phase step that is applied for the n^{th} interference pattern.

In practice at least three phase steps are needed to reconstruct the complex object wavefront. However if a greater number of phase steps are performed, the Signal-to-Noise ratio can be improved and phase step errors can be reduced. Typically, tens or hundreds of phase steps may be applied.

The interference patterns from the various phase steps are then combined to form a dark field image of the object 702.

Once the system 700 has been used to image an object 702 in the manner described above, it can then be used to image a second object in the same way. This can be achieved either by moving the system (at least in part), or by removing the object 702 and replacing it with the new object 702′.

The computer in the computer/controller module 732 then compares the complex object field of the first object 702 and the new object 702′, for example by performing a subtraction of one from the other. In this way, differences between the two objects can be easily observed. This means that, when the object 702 is a reference reticle and the new object 702′ is a test reticle that is meant to have the same pattern as the reference reticle, the similarity can be verified and the new object 702′ can be tested for the presence of defects.

The radiation source 706 may in some embodiments be a monochrome laser. However in alternative embodiments the radiation source 706 may be a source that emits radiation at a number of different wavelengths, and as a specific example might be a white light source.

The use of a radiation source 706 that emits radiation at a number of different wavelengths enables the gathering of spectroscopic information of the scattered field as well. For each phase step, the complex amplitude of many different wavelengths can be measured and stored simultaneously. This allows wavelength-dependent scattering properties to be exploited as an extra discriminating factor, which can help improve the detectability of defects, as a defect may typically exhibit a different spectroscopic response than that of the surface of the object being imaged. To enable this spectroscopic distinguishability with the same image resolution as for a monochrome light source, typically a larger number of phase steps will be required, as is discussed above. The use of the two counter-propagating wedges 728, 730, illustrated as an example in FIG. 7, can be helpful when using a radiation source 706 that emits radiation at a number of different wavelengths, because this requires a larger optical path difference as compared with a monochrome radiation source 706, and the two counter-propagating wedges 728, 730 are capable of adjusting the optical path over a relatively large range as mentioned above and so is a good choice to ensure sufficient spectral resolution.

The use of the 0^{th} order reflected light from the object as the reference path means the system 700 is intrinsically insensitive to vibrations, as any motion of the object 702 affects both the reference branch and the probe branch resulting in a common mode variation of the image detected at the detector 752.

The system 700 can also include an optional monitoring device 754, 755 including a radiation sensor 754, optional optical element 755, and appropriate software to be executed in the computer/controller module 732. The monitoring device 754, 755 receives radiation from the beam splitter 710. In one embodiment the radiation sensor may 754 include a photodiode. The radiation sensor 754 is used to feed intensity noise data to the computer of the computer/controller module 732. The intensity noise data can be used to normalize the images that are acquired with the detector 752. The normalization of the images helps to correlate the phase stepped images of each imaged object, and the comparison of the complex fields of the reference object 702 with the test object 702′, thus further improving the sensitivity and accuracy of defect detection.

The monitoring device 754, 755 may also be applied to other embodiments, including the bright field systems of FIGS. 2 to 6 and variations thereof.

In further embodiments, the object inspection systems of any of FIGS. 2 to 7 can optionally include a filtering system between lens 248, 548, 750 and the respective detector. The filtering system can include, for example, two Fourier lenses with a spatial filter between them that cancel out unwanted radiation or energy. Using a filtering system can provide a better output signal-to-noise ratio, and is especially useful when the pattern of the object pattern has a periodic component.

Also, although the embodiments described above are described for use with reflective objects/reticles, the embodiments of the present invention can also be applied for use with transmissive objects/reticles. In that case, the light sources shown in FIGS. 2 to 7 would illuminate the various respective objects from below as shown in the figures.

The use of phase detection in each of the above embodiments and in variations thereof (through comparison of the complex fields) results in an increased sensitivity to detection of defects as compared with prior art intensity based detection as mentioned in the discussion of the Background Art above. This is particularly useful for the detection of smaller defects, having a characteristic dimension of 100 nm or less, preferably 20 nm or less.

The objects 202/202′, 502/502′, 702/702′ that can be imaged by systems according to the above embodiments may in an embodiment be a lithographic patterning device for generating a circuit pattern to be formed on an individual layer in an integrated circuit. Example patterning devices include a mask, a reticle, or a dynamic patterning device. Reticles for which the systems can be used include for example reticles with periodic patterns and reticles with non-periodic patterns. The reticles can also be reticles for use with any lithography process, such as EUV lithography and imprint lithography for example.

The embodiment shown in FIG. 7 operates as a dark field system. It will be appreciated that the embodiments shown in FIGS. 2 to 6 may be modified to operate as dark field systems if desired.

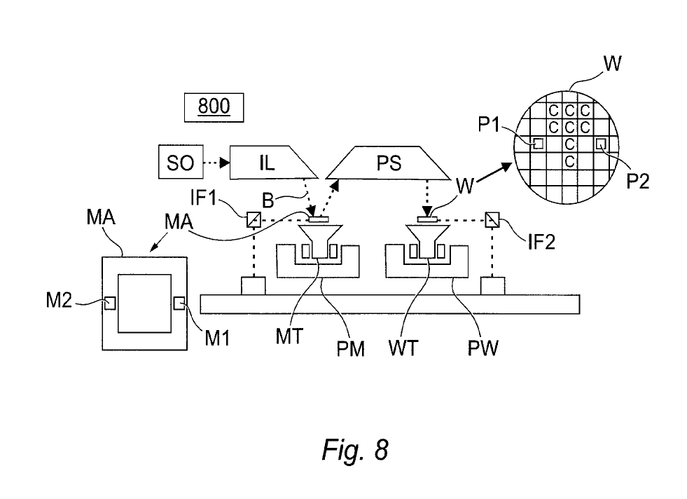

The embodiments described above are depicted as separate devices. Alternatively, they may optionally be provided as an in-tool device, that is, within a lithographic system. As a separate apparatus, it can be used for purposes of reticle inspection (e.g., prior to shipping). As an in-tool device, it can perform a quick inspection of a reticle prior to using the reticle for a lithographic process. FIGS. 8 to 10 illustrate examples of lithographic systems that can incorporate a reticle inspection system as an in-tool device. In FIGS. 8 to 10, reticle inspection system 800 is shown together with the respective lithography system. The reticle inspection system 800 can be the object inspection system of any of the embodiments illustrated in FIGS. 2 to 7, or variations thereof.

The following description presents detailed example environments in which embodiments of the present invention may be implemented.

FIG. 8 schematically depicts a lithographic apparatus according to one embodiment of the invention. The apparatus includes:

an illumination system (illuminator) IL that receives a radiation beam from a radiation source SO, and which is configured to condition a radiation beam B (e.g. EUV radiation).

a support structure (e.g. a mask table) MT constructed to support a patterning device (e.g. a mask or a reticle) MA and connected to a first positioner PM configured to accurately position the patterning device MA;

a substrate table (e.g. a wafer table) WT constructed to hold a substrate (e.g. a resist coated wafer) W and connected to a second positioner PW configured to accurately position the substrate WT; and

a projection system (e.g. a reflective projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structures MT and WT hold objects, including a patterning device MA and support structure WT respectively. Each support structure MT, WT holds its respective object MA, W in a manner that depends on the orientation of the object MA, W, the design of the lithographic apparatus, and other conditions, such as for example whether or not the object MA, W is held in a vacuum environment. Each of the support structures MT, WT can use mechanical, vacuum, electrostatic or other clamping techniques to hold the objects MA, W. The support structures MT, WT may include a frame or a table, for example, which may be fixed or movable as required. The support structures MT, WT may ensure that the respective objects MA, W are at a desired position, for example with respect to the projection system PS.

With the aid of the second positioner PW and position sensor IF2 (e.g., an interferometric device, linear encoder or capacitive sensor), the substrate table WT may be moved accurately, e.g. so as to position different target portions C in the path of the radiation beam B. Similarly, the first positioner PM and another position sensor IF1 may be used to accurately position the patterning device (e.g., mask) MA with respect to the path of the radiation beam B. Patterning device (e.g., mask) MA and substrate W may be aligned using mask alignment marks M1, M2 and substrate alignment marks P1, P2.

The term “patterning device” should be broadly interpreted as referring to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” may encompass any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. It may be desired to use a vacuum for EUV or electron beam radiation since other gases may absorb too much radiation or electrons. A vacuum environment may therefore be provided to the whole beam path with the aid of a vacuum wall and vacuum pumps.

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

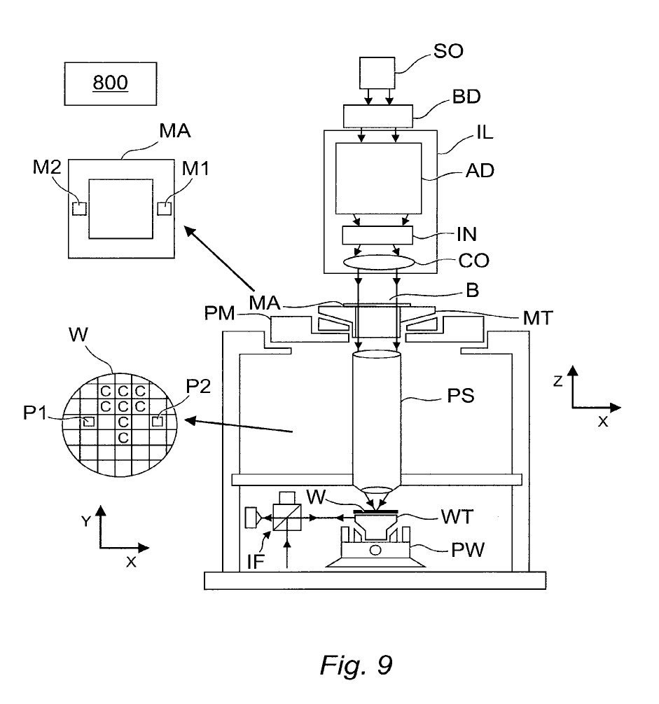

As depicted in FIG. 8, the apparatus is of a reflective type (e.g. employing a reflective mask). Alternatively, the apparatus may be of a transmissive type (e.g. employing a transmissive mask). A transmissive type apparatus is shown in FIG. 9.

Referring to FIG. 9, the illuminator IL receives a radiation beam from a radiation source SO. The source and the lithographic apparatus may be separate entities, for example when the source SO is an excimer laser. In such cases, the source SO is not considered to form part of the lithographic apparatus and the radiation beam is passed from the source SO to the illuminator IL with the aid of a beam delivery system BD including, for example, suitable directing mirrors and/or a beam expander. In other cases the source SO may be an integral part of the lithographic apparatus, for example when the source SO is a mercury lamp. The source SO and the illuminator IL, together with the beam delivery system BD if required, may be referred to as a radiation system.

The illuminator IL may include an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator IL may be used to condition the radiation beam, to have a desired uniformity and intensity distribution in its cross section.

The radiation beam B is incident on the patterning device (e.g., mask) MA, which is held on the support structure (e.g., mask table) MT, and is patterned by the patterning device. After traversing the patterning device (e.g. mask) MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor (not shown) can be used to accurately position the patterning device (e.g. mask) MA with respect to the path of the radiation beam B. Patterning device (e.g. mask) MA and substrate W may be aligned using mask alignment marks M1, M2 and substrate alignment marks P1, P2.

FIG. 9 also illustrates a number of other components used in a transmissive type lithographic apparatus, the form and operation of which will be familiar to a skilled artisan.

The depicted apparatus of both FIGS. 8 and 9 could be used in at least one of the following modes:

1. In step mode, the support structure (e.g. mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed.
2. In scan mode, the support structure (e.g. mask table) MT and the substrate table WT are scanned synchronously while a pattern imparted to the radiation beam is projected onto a target portion C (i.e. a single dynamic exposure). The velocity and direction of the substrate table WT relative to the support structure (e.g. mask table) MT may be determined by the (de-) magnification and image reversal characteristics of the projection system PS.
3. In another mode, the support structure (e.g. mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

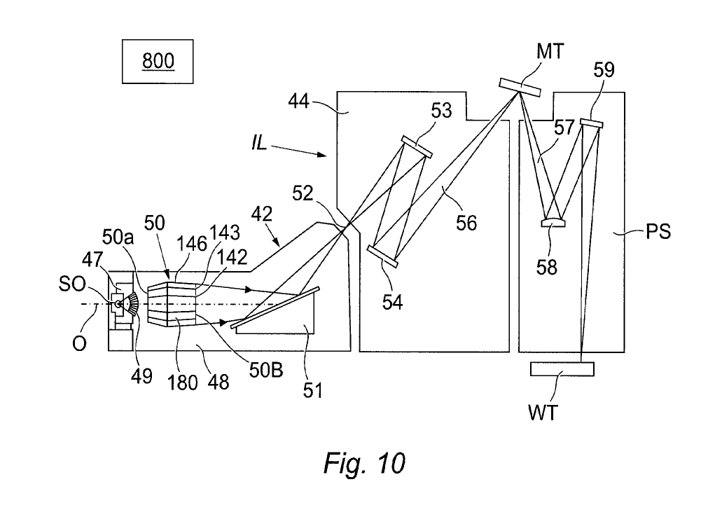

FIG. 10 shows the apparatus of FIG. 8 in more detail, including a radiation system 42, the illumination system IL, and the projection system PS. The radiation system 42 includes the radiation source SO which may be formed by a discharge plasma. EUV radiation may be produced by a gas or vapor, for example Xe gas, Li vapor or Sn vapor in which a very hot plasma is created to emit radiation in the EUV range of the electromagnetic spectrum. The very hot plasma is created by causing an at least partially ionized plasma by, for example, an electrical discharge. Partial pressures of, for example, 10 Pa of Xe, Li, Sn vapor or any other suitable gas or vapor may be required for efficient generation of the radiation. In an embodiment, a Sn source is applied as an EUV source. The radiation emitted by radiation source SO is passed from a source chamber 47 into a collector chamber 48 via an optional gas barrier or contaminant trap 49 (in some cases also referred to as contaminant barrier or foil trap) which is positioned in or behind an opening in source chamber 47. The contaminant trap 49 may include a channel structure. Contamination trap 49 may also include a gas barrier or a combination of a gas barrier and a channel structure. The contaminant trap or contaminant barrier 49 further indicated herein at least includes a channel structure, as known in the art.

The collector chamber 48 may include a radiation collector 50 which may be a grazing incidence collector (including so-called grazing incidence reflectors). Radiation collector 50 has an upstream radiation collector side 50a and a downstream radiation collector side 50b. Radiation passed by collector 50 can be reflected off a grating spectral filter 51 to be focused in an intermediate focus point 52 at an aperture in the collector chamber 48. The beam of radiation emanating from collector chamber 48 traverses the illumination system IL via so-called normal incidence reflectors 53, 54, as indicated in FIG. 10 by the radiation beam 56. The normal incidence reflectors direct the beam 56 onto a patterning device (e.g. reticle or mask) positioned on a support (e.g. reticle or mask table) MT. A patterned beam 57 is formed, which is imaged by projection system PS via reflective elements 58, 59 onto a substrate carried by wafer stage or substrate table WT. More elements than shown may generally be present in illumination system IL and projection system PS. Grating spectral filter 51 may optionally be present, depending upon the type of lithographic apparatus. Further, there may be more mirrors present than those shown in the Figures, for example there may be 1-4 more reflective elements present than the elements 58, 59 shown in FIG. 2. Radiation collectors similar to radiation collector 50 are known from the prior art.

Radiation collector 50, is described herein as a nested collector with reflectors 142, 143, and 146. The nested radiation collector 50, as schematically depicted in FIG. 10, is herein further used as an example of a grazing incidence collector (or grazing incidence collector mirror). However, instead of a radiation collector 50 including a grazing incidence mirror, a radiation collector including a normal incidence collector may be applied. Hence, where applicable, collector mirror 50 as grazing incidence collector may also be interpreted as collector in general and in a specific embodiment also as normal incidence collector.

Further, instead of a grating 51, as schematically depicted in FIG. 10, also a transmissive optical filter may be applied. Optical filters transmissive for EUV and less transmissive for or even substantially absorbing UV radiation are known in the art. Hence, “grating spectral purity filter” is herein further indicated as “spectral purity filter” which includes gratings or transmissive filters. Not depicted in schematic FIG. 10, but also included as optional optical elements may be EUV transmissive optical filters, for instance arranged upstream of collector mirror 50, or optical EUV transmissive filters in illumination system IL and/or projection system PS.

The radiation collector 50 is usually placed in the vicinity of the source SO or an image of the source SO. Each reflector 142, 143, 146 may include at least two adjacent reflecting surfaces, the reflecting surfaces further from the source SO being placed at smaller angles to the optical axis O than the reflecting surface that is closer to the source SO. In this way, a grazing incidence collector 50 is configured to generate a beam of (E)UV radiation propagating along the optical axis O. At least two reflectors may be placed substantially coaxially and extend substantially rotationally symmetric about the optical axis O. It should be appreciated that radiation collector 50 may have further features on the external surface of outer reflector 146 or further features around outer reflector 146. For example, a further feature may be a protective holder, or a heater. Reference number 180 indicates a space between two reflectors, e.g. between reflectors 142 and 143.

During use, on one or more of the outer reflectors 146 and inner reflectors 142 and 143 deposition may be found. The radiation collector 50 may be deteriorated by such deposition (deterioration by debris, e.g. ions, electrons, clusters, droplets, electrode corrosion from the source SO). Deposition of Sn, for example due to a Sn source, may, after a few mono-layers, be detrimental to reflection of the radiation collector 50 or other optical elements, which may necessitate the cleaning of such optical elements.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc.

Although specific reference may have been made above to the use of embodiments of the invention in the context of optical lithography, it will be appreciated that the invention may be used in other applications, for example imprint lithography, and where the context allows, is not limited to optical lithography.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

It is also to be appreciated that in the embodiments above, an optical path length difference between a first optical path from the illumination source to the detector and a second optical path from the illumination source to the detector should be less than a coherence length of the illumination source. An optical path (or optical path length) is a product of geometrical length (s) and refractive index (n) as shown in the following equation: OPL=c∫n(s)ds, where integration is along a ray. In an example case of straight rays in two branches (from the light source to the detector) with uniform mediums, the optical path difference (OPD) is equal to (n1*s1)−(n2*s2).

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. An object inspection system, comprising:
a radiation source arranged to emit a reference radiation beam;
a radiation source arranged to emit a probe radiation beam to be incident on an object to be inspected;
one or more optical elements arranged to interferometrically combine said reference radiation beam and said probe radiation beam;
a storage medium arranged to store the complex field image of a reference object; and
a comparator arranged to compare a complex field image of the object to be inspected with the stored complex field image of the reference object.

2. The object inspection system of claim 1, further comprising a beam splitter and wherein a single radiation source emits a radiation beam that interacts with the beam splitter to form the reference radiation beam and the probe radiation beam.

3. The object inspection system of claim 1, wherein said one or more optical elements comprises a reflective element arranged to deflect the reference radiation beam in order to provide said reference radiation beam as a tilted reference radiation beam for interference with the probe radiation beam.

4. The object inspection system of claim 1, wherein said storage medium comprises an optical storage device.

5. The object inspection system of claim 4, wherein the optical storage device comprises a holographic plate or a crystal.

6. The object inspection system of claim 5, wherein the storage medium with a stored complex field image of a reference object is placed in opposition of phase with the probe radiation beam reflected from the object to be inspected, so that only differences between the complex field image of the object to be inspected as compared with the stored complex field image of the reference object are transmitted.

7. The object inspection system of claim 1, wherein said one or more optical elements comprises a phase shifter that introduces a phase shift to the reference radiation beam before it is combined with the probe radiation beam.

8. The object inspection system of claim 7, wherein the phase shifter can apply a selectable phase shift.

9. The object inspection system of claim 7 further comprising:
an image sensor which detects interference patterns obtained from the interferometrically combined reference radiation beam and probe radiation beam; and
a computer for combining a plurality of detected interference patterns to obtain a complex field image of the object under inspection, and comprising said storage medium.

10. (canceled)

11. (canceled)

12. (canceled)

13. (canceled)

14. (canceled)

15. (canceled)

16. (canceled)

17. (canceled)

18. (canceled)

19. A method of inspecting an object comprising: interferometrically combining a reference radiation beam with a probe radiation beam to obtain a complex field image of the object; storing the complex field image of the object; and comparing the complex field image of the object with a reference complex field image.

20. The method of claim 19, wherein the reference radiation beam and probe radiation beams are derived from a single radiation source, the output beam of which is split into said reference radiation beam and probe radiation beam.

21. The method of claim 19, wherein the reference complex field image is obtained from a prior inspected object.

22. The method of claim 19, wherein the step of interferometrically combining the reference radiation beam with the probe radiation beam comprises providing a reference radiation beam that is tilted with respect to the probe radiation beam to create an interference pattern.

23. The method of claim 22, wherein the step of storing the complex field image of the object comprises writing the interfered reference and probe radiation beam to an optical storage device.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. A lithography system having an object inspection system, the object inspection system comprising: a radiation source arranged to emit a reference radiation beam; a radiation source arranged to emit a probe radiation beam to be incident on an object to be inspected; one or more optical elements arranged to interferometrically combine said reference radiation beam and said probe radiation beam; a storage medium arranged to store the complex field image of a reference object; and a comparator arranged to compare a complex field image of the object to be inspected with the stored complex field image of the reference object.
